(19) United States
(12) Patent Application Publication
(10) Pub. No.: US 2012/0121814 A1
(43) Pub. Date: May 17, 2012

(54) Sealed Metered Coating Apparatus

(76) Inventors: Robert Eugene Krautkramer, Combined Locks, WI (US); Douglas Wayne Stage, Appleton, WI (US); Frank Stephen Hada, Appleton, WI (US)

(21) Appl. No.: 12/944,383

(22) Filed: Nov. 11, 2010

(51) Int. Cl. B05D 1/28; B05C 11/02; B05C 13/00

(52) U.S. Cl. 427/428.01; 118/500; 118/100

(57) ABSTRACT

The present invention relates to an apparatus for applying a coating, preferably a high viscosity coating to a supported web, preferably tissue. The apparatus of the present invention comprises a sealed coating chamber that can be supplied with coating material under pressure. The chamber further comprises a metering device at its trailing edge, which applies a thin layer of coating material to an applicator roll. In general, the coater is designed to have a small footprint, allowing it to fit into tight locations and be readily adapted for use in existing tissue manufacturing and converting processes. The coater also has the advantage of having a sealed coating chamber, which permits coating material to be supplied under pressure and preventing contamination of the coating material by debris common to the coating process.

### TECHNICAL FIELD

This invention relates to a method and apparatus for applying a coating material to a web and more particularly to a sealed metered coating apparatus capable of applying high viscosity coatings to low bulk cellulosic webs in a novel and improved manner.

### BACKGROUND

Rod coating technology has been developed for coating on paper, and has been adapted to provide a wide coat weight range, ease of operation, precise coat weight regulation, and good cross machine uniformity. Traditional rod coaters however, are poorly suited to applying coating to tissue. Tissue machines run at a high rate of speed, typically in excess of 5000 feet per minute. Low viscosity coatings tend to be absorbed into the sheet and therefore require larger add-on levels for the same level of surface feel. It can be seen that the application of coatings having high viscosities, often in excess of 500 centipoises, is beneficial for a tissue sheet. Traditional coating methods, like rotogravure, are not suitable for applying high viscosity coatings. Tissue machines also produce large amounts of dust and debris, which can contaminate coating material of traditional coaters, which do not retain coating material in a sealed environment.

Therefore, a need exists for a coater specifically adapted for use in coating tissue webs and more particularly for applying high viscosity coatings to tissue webs. Accordingly, the present invention provides a coater that overcomes the limitations of prior art coaters.

### SUMMARY

It has been discovered that a new sealed coating apparatus having a metering device at its trailing edge, which applies a thin layer of coating material to an applicator roll, is particularly well suited for applying high viscosity coating materials to tissue. In general, the coater is designed to have a small footprint, allowing it to fit into tight locations and be readily adapted for use in existing tissue manufacturing and converting processes. The coater also has the advantage of having a sealed coating chamber, which permits coating material to be supplied under pressure. The introduction of coating material into a sealed environment under pressure has two distinct advantages over prior art coaters. First, it effectively eliminates contamination of the coating material by dust and particulate, which are common in the tissue manufacturing and converting process. Second, it facilitates the application of high viscosity coatings to the surface of tissue products. One skilled in the art will appreciate, however, that while the invention described herein is particularly useful to the application of high viscosity coating to tissue, the present invention is not so limited. The coater of the present invention may be used to apply coatings having a wide range of viscosities, both high and low, to a wide range of base sheets, including both cellulosic and non-cellulosic webs having a breadth of basis weights and bulks.

Hence in one aspect, the invention resides in an apparatus for coating a supported web comprising an applicator roll for supporting a web of paper; a chamber extending substantially across the face of, and parallel to, the applicator roll, the chamber having leading, trailing and side edges, the side edges having a sealing means for sealing the chamber when the chamber is positioned against the applicator roll; a first barrier wall oriented parallel to the trailing edge of the chamber, the barrier wall comprising a mayer rod and a mayer rod holder, the mayer rod abutting the applicator roll and extending laterally across a width of the roll to define a substantially closed application zone there between for applying coating to the web and for forming a seal between the trailing edge of the chamber and the applicator roll; a second barrier wall oriented parallel to the leading edge of the chamber, the second barrier wall abutting the applicator roll to form a seal between the leading edge of the chamber and the applicator roll; and a means for delivering coating liquid to the chamber under pressure.

In another aspect, the invention resides in a sealed applicator for applying high viscosity coatings to a moving web of tissue paper, the applicator comprising an applicator roll for supporting a web of tissue paper; an elongate body defining a chamber with an elongate opening thereto positionable adjacent to and transversely across the applicator roll, the chamber further having a curved wall opposite from the opening and first and second side walls which extend from the curved wall toward the opening, the first and second sidewalls having a resilient seal configured complementary to the applicator roll for sealing the sidewalls thereto when the same are moved together to seal the chamber; a metering apparatus adjoining the trailing edge of the chamber, the metering apparatus comprising a mayer rod and a support plate adapted for receiving the same, the metering apparatus abutting the applicator roll forming a seal between the trailing edge of the chamber and the applicator roll; a leading edge seal adjoining the leading edge of the chamber and abutting the applicator roll to form a seal between the leading edge of the chamber and the applicator roll; and a means for introducing high viscosity coating into the chamber, the means comprising a distribution header within the chamber, the distribution header having outlet passages and inlet passages for flowing high viscosity coating under pressure into the distribution header for flow through the outlet passages into the chamber, wherein the outlet passages direct high viscosity coating toward and against the curved wall, the curved wall deflecting the high viscosity coating for flow around opposite sides of the distribution header and through the chamber to and through the opening and onto the applicator roll.

In still other aspects the invention lies in a method of applying a high viscosity coating composition to a tissue paper web comprising presenting a web having a first surface and a second surface, the web comprising cellulosic fibers and having a bulk of greater than 3 cc/g; applying a high viscosity coating to the surface of an applicator roll traveling through an application zone having spaced leading and trailing edges, a wall intermediate the edges and spaced from the applicator roll and from the leading and trailing edges, and laterally spaced side edges, the application zone being defined between the leading and trailing edges, the high viscosity coating having a viscosity of at least about 500 centipoises (cps), measured at 25° C. using a Brookfield viscometer at 100 rpm using a #2 spindle, still more preferably a viscosity of at least about 800 cps and even more preferably a viscosity of at least about 100 cps. forming and maintaining a reservoir of high viscosity coating under pressure on the applicator roll throughout the application zone; metering the high viscosity coating on the applicator roll using a mayer rod at the trailing edge of the application zone; maintaining the high viscosity coating throughout the application zone under pressure by substantially sealing the side edges of the zone and by forming a liquid seal at a first gap defined between the applicator roll and mayer rod and by establishing seal at a second gap defined between the leading edge of the application zone and the applicator roll; and continuously flowing high viscosity coating under pressure into the application zone to continuously fill the first gap with coating for forming the liquid seal for sealing the trailing edge of the application zone and preventing entry of air and foreign matter into the application zone and for maintaining a pressurized area of coating throughout the application zone; and transferring the high viscosity coating from the applicator roll to the first surface of the web without penetrating the first surface.

### BRIEF DESCRIPTION OF THE DRAWINGS

FIG. 1 is a perspective view of one embodiment of the coater according to the present invention engaging an applicator roll.

FIG. 2 is a perspective view of one embodiment of the coater according to the present invention illustrating the configuration and arrangement of an improved coating material supply chamber and metering rod assembly.

FIG. 3 is a detailed perspective view of the metering rod assembly illustrated in FIG. 2.

FIG. 4 is an alternative perspective view of the coater illustrated in FIG. 2, illustrating further details of the distribution header and chamber, as well as an improved seal structure for establishing a fluid tight seal when the chamber engages the applicator roll.

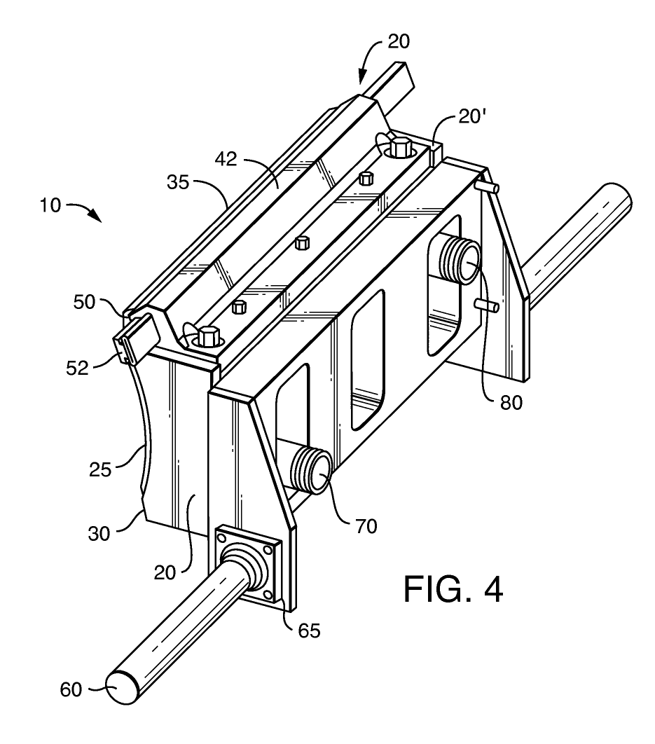

FIG. 5 is a partial cross-sectional view of the coater illustrated in FIG. 2, illustrating further details of the distribution header and chamber and metering rod assembly.

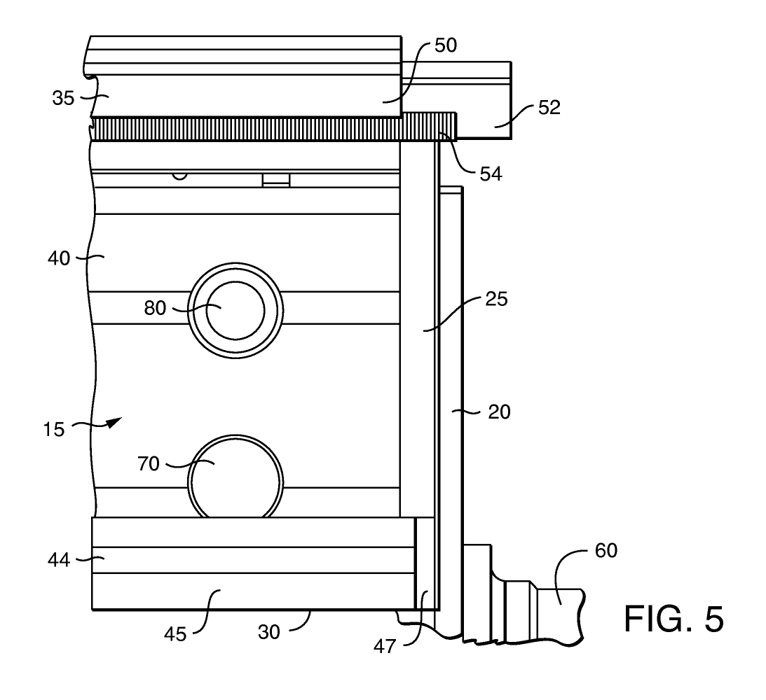

FIG. 6 is a cross sectional view at the center of the coater illustrated in FIG. 1 showing the application zone against a roll.

### DETAILED DESCRIPTION

While the coater disclosed herein is generally described as an apparatus for applying a coating to tissue, one skilled in the art will understand that the coater may be used to apply a coating to a wide range of materials. Thus, the term “tissue” is not intended to be limited to facial tissues, but is used herein to include webs having a breadth of basis weights and bulks formed from non-woven materials, spun-bond materials, and combinations of these materials with cellulose.

Further, while the coater disclosed herein is generally described as an apparatus for applying coating materials having a high viscosity, one skilled in the art will understand that the coater may be used to apply coatings having a wide range of viscosities. All viscosities disclosed in the application are referenced in terms of centipoises measured at 25° C. using a Brookfield viscometer at 100 rpm using a #2 spindle.

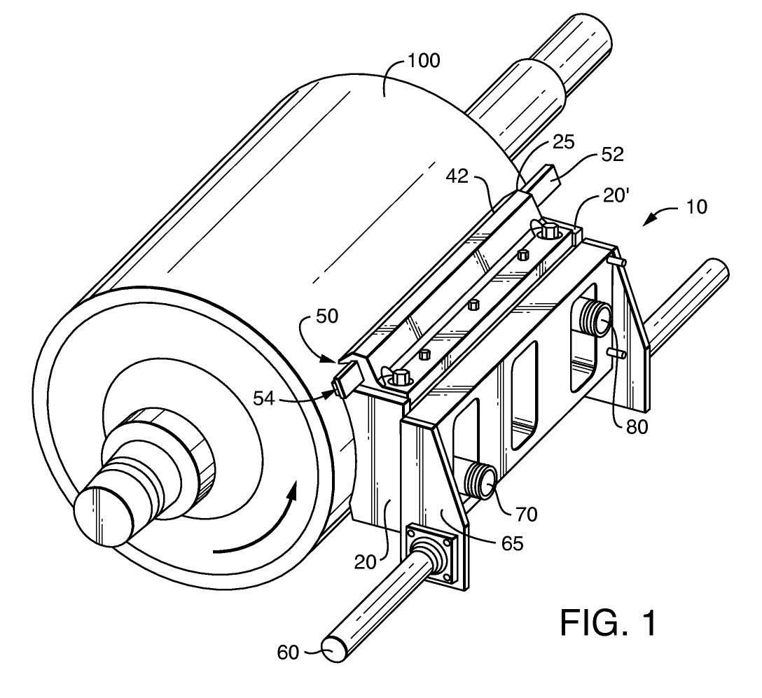

Referring to FIG. 1, in one embodiment, the coater 10 applies coating to the applicator roll 100, which in-turn transfers the coating composition to a web at the nip between the applicator roll and a backing roll (not shown). The backing roll serves to hold the paper web in continuous contact with the applicator roll. The applicator roll 100 may be of any suitable material, but preferably is a resilient roll and still more preferably is a rubber backed steel roll. The applicator roll 100 is driven in the direction of the arrow. The coater, indicated generally at 10, is elongate and extends parallel to and coextensively with the applicator roll 100. The coater 10 has a pair of sidewalls (only one of which is shown) 20 and 20′, leading 30 and trailing 50 edges and a rear wall 40, which generally define a coating material supply chamber 15. The sidewalls 20 and 20′ include side edges, each edge having a sealing means for forming a liquid tight seal when the chamber is positioned in engagement with the applicator roll. The leading 30 and trailing 50 edges also form liquid tight seals when the coater 10 is engaged with the applicator roll 100. Thus, when the coater 10 is positioned against the applicator roll 100, the entire periphery of the chamber 15 is sealed. The sealed chamber provides the additional benefit of permitting liquid coating material to be introduced into the chamber under pressure. In certain preferred embodiments where liquid coating material is introduced into the chamber under pressure it is advantageous to design the sidewalls such that pressure in the chamber enhances the sealing effect.

Preferably the position of the metering device is adjustable toward or away from the applicator roll 100 to thereby control the amount of coating which passes with the web to the final metering station. In one embodiment a pneumatic tube 52 may be used to adjust the position of the metering device 54 relative to the applicator roll 100. For most coating operations, it has been found preferable to provide a small positive clearance between the applicator roll 100 and the metering device 54 and to provide a small positive or negative clearance between the metering device 54 and roll 100. The applicator roll 100 and coating thereon passing between the metering device 54 seals the coating chamber 15 at the trailing edge.

With further reference to FIG. 1, the sidewalls 20 and 20′ comprise plates having respective brackets for mounting the end plates to the rear wall 40. Each sidewall 20 and 20′ is machined along most of its top edge to fit the contour of the applicator roll 100. Seals 25 and 25′ of suitable material, such as deformable elastomeric material, for example a thermoplastic rubber such as EDPM (Ethylene Propylene Diene Monomer), are suitably located on the interior surfaces of the sidewalls 20 and 20′ and bear against the applicator roll to form a liquid tight seal between the sidewalls 20 and 20′ and the applicator roll 100. In a preferred embodiment, to facilitate sealing of each sidewall 20 and 20′, end seal retaining grooves are formed in and along the front faces of the sidewalls 20 and 20′. Preferably the grooves are continuous and are generally U-shaped or configured as an open sided rectangle. The grooves are adapted to receive a unitary, U-shaped and square cross sectioned elastomeric seal, such as of neoprene, and the shape of the grooves are such that they hold or grasp the sides of the seal and retain it without need for adhesives or retaining devices. Consequently, a continuous square cross section seal strip inserted into the grooves provides a fluid tight connection between the sidewalls and applicator roll without need for joints or splices in the seal.

The applicator also includes a main support beam, indicated generally at 60, extending parallel to and coextensively with the applicator roll 100. The beam may be a single continuous beam passing through each of the brackets extending from the rear wall 40, or the beam may be discontinuous, as illustrated, where the back wall has a pair of brackets 65 and 65′, each adapted to receive a single support beam 60. The support beam 60 permits the entire chamber 15 to be pivotally mounted to permit the chamber 15 to be opened for cleaning and maintenance. The support beam 60 is designed to minimize deflection caused when the chamber 15 engages the applicator roll 100 and more particularly to minimize deflection in those applications where the chamber is pressurized. It is advantageous to provide an interior channel in the beam to allow a heated fluid to pass through the beam. Keeping the beam at a uniform temperature prevents deflection caused by temperature differences between the fluid and ambient air.

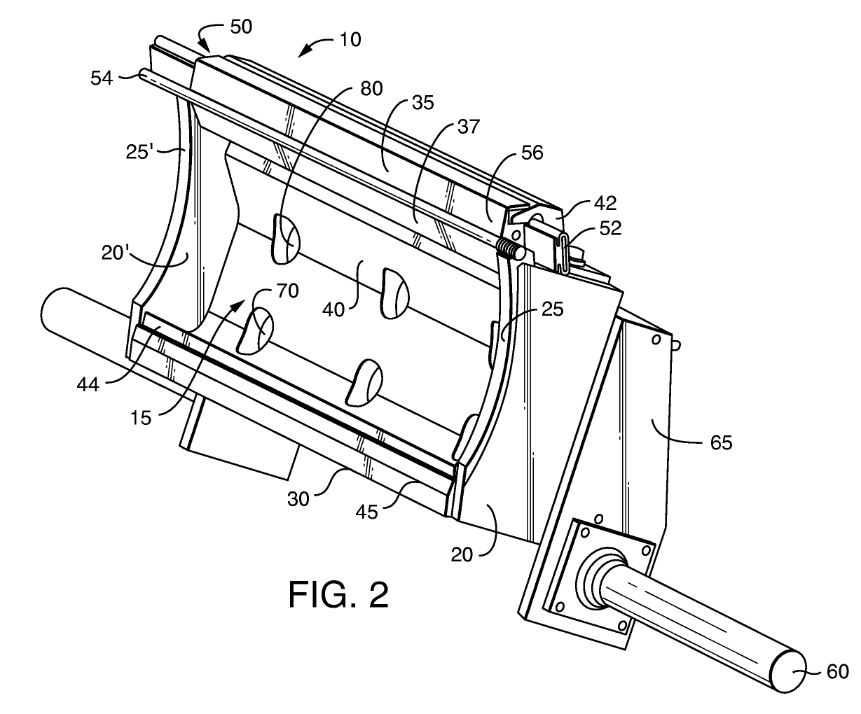

Turning to FIG. 2, a chamber 15 comprising a rear wall 40 having leading 30 and trailing 50 edges and a pair of sidewalls 20 and 20′ is illustrated in further detail. The rear wall 40 of the chamber is preferably curved having a bottom edge member 45 extending in the direction of the applicator roll 100 to form a reservoir for coating material and a leading edge 30. The rear wall 40 preferably also has an edge member 35, which also extends in the direction of the applicator roll 100 to form the trailing edge 35. A pair of sidewalls 20 and 20′ are connected to either end of the rear wall 40. Again, each sidewall 20 and 20′ of the chamber 15 is machined along most of its top edge to fit the contour of the applicator roll 100 and are preferably fitted with seals 55 and 55′ that bear against the applicator roll to prevent coating from leaking from the sidewalls 20 and 20′.

With further reference to FIG. 2, in a preferred embodiment the leading edge of the coating chamber 15 is sealed by blade 44 which is housed in the bottom edge member 45. The blade holder 45 is secured to the bottom edge of the back member 40. The blade 44 preferably extends from sidewall 20 to sidewall 20′ and bears at its tip against applicator roll 100 to seal the leading edge 30 of the chamber 15. In another embodiment the leading edge 30 of the chamber 15 may comprise a gasket or seal affixed to the bottom edge of the back member, the gasket or seal forming a liquid impervious seal when the coater 10 is positioned against the applicator roll 100. In still other embodiments the bottom edge of the back member 40 may be shaped such that when the chamber 15 is positioned against the applicator roll 100 and coating material is introduced to the chamber, preferably under pressure, coating material floods the gap between the bottom edge and the applicator roll forming a seal.

With further reference to FIG. 2 one preferred embodiment for sealing the trailing edge 35 of the coater 15 is illustrated. In the illustrated embodiment a barrier wall 40 comprising a metering device 54 and metering device support member 56 is affixed at the trailing edge 35 of the coater by a mounting member 42. In a particularly preferred embodiment the mounting member 42 is adapted to receive a pneumatic tube 52. The pneumatic tube 52 may be used to control the position of the metering device 54 relative to the applicator roll. In a preferred embodiment the pneumatic tube 52 is expandable by the introduction of fluid or air under pressure therein to press the metering device 54 against the applicator roll thereby forming a seal at the trailing edge of the chamber. By controlling the distance between the metering device 54 and the applicator roll 100, the pneumatic tube 52 may also be used to control the amount of coating applied to the surface of applicator roll 100.

In another preferred embodiment the trailing edge of the coating chamber 15 is sealed by coating material flooding a gap formed between the applicator roll 100 and the coating metering device 54. In a particularly preferred embodiment the metering device is a mayer rod, which is supported by a mayer rod retaining member 56. As used herein, the term “mayer rod” generally refers to a substantially circular rod used to meter the amount of coating material applied to the applicator roll. The mayer rod may be smooth or may have a plurality of grooves disposed thereupon. In certain embodiments where the mayer rod is grooved, the grooves may be formed by either wrapping the rod with wire or machining. Mayer rods are commercially available from several manufactures including, RD Specialties, Webster, N.Y.

In a preferred embodiment the mayer rod is a stainless steel rod that is wrapped with wire, which results in a rod surface having recessed and raised portions. Generally, the amount of coating applied to the sheet is governed in-part by the cross-sectional area of the recessed portion. The spacing, arrangement and diameter of the wrapped wire also influence the initial shape of the coating applied to the sheet. The wire wrapped coating surface generally results in the coating being applied as a series of stripes, spaced apart according to the spacing of the recessed portions, however, normal surface tension pulls these stripes together, forming a relatively uniform surface. Preferably the mayer rod is wrapped with wire having a diameter in the range from about 0.05 to about 3 mm and more preferably from about 0.1 to about 1 mm. In other embodiments, the surface of the mayer rod may be machined, rather than wrapped with wire, to create a surface having a plurality of grooves.

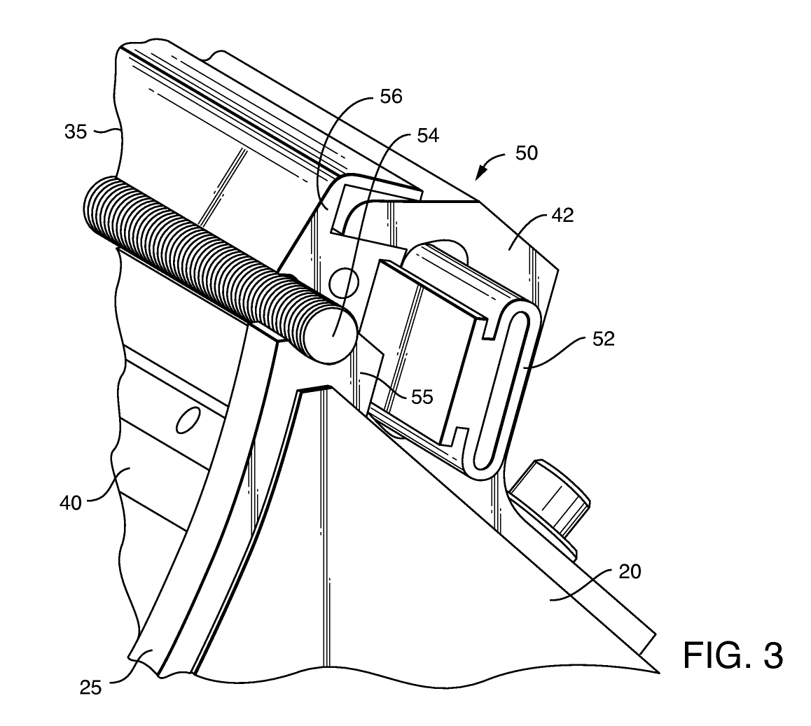

With further reference to FIG. 3, one embodiment of the first barrier wall 50, which seals the trailing edge 35 of the coater 10, is illustrated in detail. In a preferred embodiment, the first barrier wall 50 comprises a mayer rod 54 and a mayer rod support member 56. The mayer rod support member 56 preferably extends parallel to and coextensively with the applicator rolls 100 and is adjoined to the top edge member extending from the back wall 40 of the chamber 15. In certain embodiments the mayer rod 54 may be biased against the applicator roll 100 by a pneumatic device 52 engaged with, or integrated with, the mayer rod holder 42. In one embodiment the pneumatic device 52 is retained by a mounting member 42 which is also adapted to receive the mayer rod holder 56. Preferably the mounting member 42 extends transversely along the upper edge of the chamber 15 and is mounted to the upper edge of the back wall 40. The support member 42 converges toward the applicator roll 100, and has a free upper edge which is shaped to receive the mayer rod holder 56. The pneumatic tube 52 positioned in the transversely extending channel of the support member 42 may be used to position the mayer rod 54 against the applicator roll by the introduction of pressure to the tube, which in-turn causes the mayer rod 54 to be pressed against the applicator roll. Preferably the pneumatic tube comprises a bladder whose pressure can be adjusted from about 0 to about 50 psi and more preferably from about 5 to about 40 psi. It is also further preferred that the assembly, including the rod holder 56 and air bladder 52 are preferably sufficiently flexible such that at air bladder pressures of about 2 to about 5 psi the rod 54 is uniformly loaded against the applicator roll 100.

In use, excess coating material introduced into the application zone, defined generally by the area between the leading and trailing edges of the chamber, floods the gap between the metering device and the applicator roll. By flooding the gap between the metering device and the applicator roll a liquid seal is formed at the trailing edge of the coater, thereby enabling pressurized application of coating material onto the applicator roll in the zone. As the applicator roll travels through the applicator zone, coating material is applied to the surface of the roll. As the applicator roll leaves the applicator zone, excess coating is metered from the roll to the desired final level by the metering devices, which in a preferred embodiment is a mayer rod.

In one embodiment the excess coating may be directed towards the applicator pan by channel member to the coating return portion of the applicator pan. The coating return portion of the applicator pan may include a drain which leads to a conduit having a screen, allowing the returned coating material to be screened before being reintroduced to the chamber. In another embodiment the edge of the chamber may comprise a splash plate extending downwardly and outwardly from the forward edge to guide liquid coating material flowing through the gap into the chamber for collection and recirculation.

In operation coating liquid is introduced into the chamber in sufficient quantity to completely fill the chamber. In a particularly preferred embodiment the coating liquid is introduced to the chamber under pressure. Filling the chamber with the coating liquid causes a continuous, copious flow of coating material, preferably in the direction of applicator roll travel, flooding the gaps between the applicator roll and the chamber sealing blade and metering device. This forms a liquid seal between the edge and the applicator roll and causes the coating liquid to be applied to the applicator roll in a very narrow transverse band under a constant positive pressure. The excess of coating liquid that flows through the gaps at the leading and trailing edges of the coater, in the direction of applicator roll travel, forms a liquid seal between the coater and the applicator roll, causing the coating liquid within the chamber to be maintained under pressure and to be applied to the applicator roll under pressure. The liquid seals at the leading and trailing edges also seal off the coating chamber preventing entry of air and foreign matter.

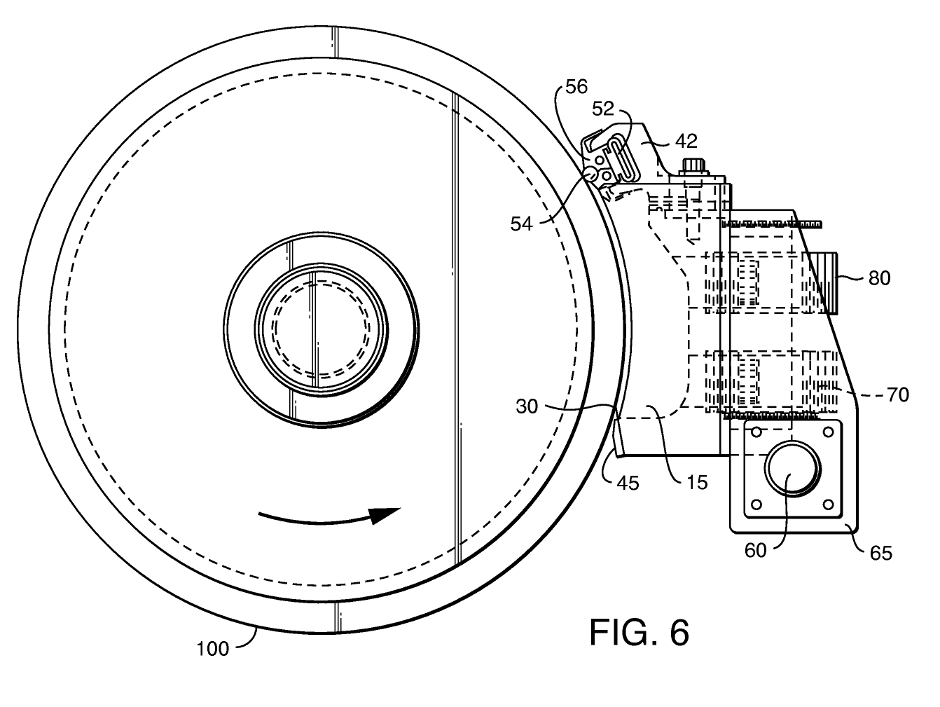

When using the coater to apply high viscosity coatings to tissue, it is important that the applicator incorporate a coating material supply chamber and a coating material distribution header of a design such that coating material is uniformly distributed to and applied on the applicator roll and doctored evenly to produce a uniform coat weight. Accordingly, in a preferred embodiment the chamber is shaped such that its upper wall converges towards the applicator roll near the metering slot, causing the coating material to accelerate as it approaches the slot. In one embodiment the back wall of the chamber may be curved to achieve this effect. In another embodiment, such as the chamber illustrated in FIG. 6, the upper and lower portion of the rear wall 40 may have two distinct shapes. The lower wall may be generally J-shaped with a substantially planar portion, or a semicircular lower wall which terminates with a substantially planar bottom member orientated transversely to the applicator roll 100. In the embodiment illustrated in FIG. 6, the upper portion of the rear wall 40 preferably converges towards the applicator roll 100, reducing the volume of the chamber approaching the metering device 54 and causing the coating material to accelerate as it approaches the metering device 54.

The size of the chamber 15 may vary as the size of the applicator roll 100 is varied. It has been found that a contact angle of at least 60° is preferred; however contact angles in the range of from about 40° to about 180° are within the scope of this invention. The contact angle is the number of degrees of applicator roll circumference which is in contact with the applicator pan at one time, i.e., that portion of the applicator roll 100 between the leading 30 and trailing 35 edges.

In one embodiment of the invention, coating material from the fresh coating feed line is moved by pump through a conduit to a coating distributor which is suitably secured to the back of the coating chamber. Preferably, the delivery pump delivers coating to the coating chamber under hydrostatic pressure. Pressures may range from about 0.02 to about 0.5 bars and still more preferably from about 0.1 to about 0.2 bars. When applying high viscosity coatings according to the present invention, maintaining the coating chamber under pressure is an important feature of the present invention. By employing a hydrostatic head to pressurize the coating chamber 15, high coat weights are achieved by the pressurized coating being driven into the traveling web.

In addition to the teardrop shape of the chamber, according to another aspect of the invention there is provided a pair of inlet openings that discharges coating material through the lower portion of the rear wall. Preferably, the coating material is discharged through the inlets such that the coating liquid completely fills the coating chamber. In consequence, the flow of coating material from the distribution header is uniformly spread out and distributed to opposite sides of the coating chamber, and flows around the chamber into the upper tapered portion of the chamber and towards the metering device for uniform application and metering of the coating material on the applicator roll. Excess coating is removed from the chamber by a pair of outlet openings located on the upper part of the rear wall.

In other embodiments, the coater may comprise two or more distribution header outlets. Preferably the spacing between the distribution header outlet openings is from about 6 to about 12 inches, center to center, and still more preferably from about 8 to about 10 inches. The spacing of the header outlet openings may depend in-part on the coating material formulation and rheology used. The diameter of the openings preferably ranges from about 0.5 to about 5 inches and still more preferably from about 1 to about 3 inches. All of the openings need not be of the same diameter, and several may be either larger or smaller toward the center of the distribution header to facilitate uniform distribution with some coating formulations.

In operation, the coater may be adapted to apply coating to a tissue web. In one embodiment the tissue web is formed on a forming fabric, suitably supported and driven by rolls, which receives the layered papermaking stock issuing from the head box. Once retained on fabric, the layered fiber suspension passes water through the fabric. Water removal is achieved by combinations of gravity, centrifugal force and vacuum suction depending on the forming configuration. When forming multiple ply products, the resulting paper product may comprise two plies, three plies, or more. Each adjacent ply may contain the coating composition or at least one of the plies adjacent to one another may contain the coating composition. The individual plies can generally be made from the same or from a different fiber furnish and can be made from the same or a different process.

The tissue web bulk may also vary from about 3 cc/g to about 20 cc/g, such as from about 5 cc/g to about 15 cc/g. The sheet “bulk” is calculated as the quotient of the caliper of a dry tissue sheet, expressed in microns, divided by the dry basis weight, expressed in grams per square meter. The resulting sheet bulk is expressed in cubic centimeters per gram. More specifically, the caliper is measured as the total thickness of a stack of ten representative sheets and dividing the total thickness of the stack by ten, where each sheet within the stack is placed with the same side up. Caliper is measured in accordance with TAPPI test method T411 om-89 “Thickness (caliper) of Paper, Paperboard, and Combined Board” with Note 3 for stacked sheets. The micrometer used for carrying out T411 om-89 is an Emveco 200-A Tissue Caliper Tester available from Emveco, Inc., Newberg, Oreg. The micrometer has a load of 2.00 kilo-Pascals (132 grams per square inch), a pressure foot area of 2500 square millimeters, a pressure foot diameter of 56.42 millimeters, a dwell time of 3 seconds and a lowering rate of 0.8 millimeters per second.

From there the web is threaded through the drying section of the machine. In most cases, a first air dryer and second air dryer are used; however, there is also an option to use an infrared dryer. After the dryer section, the sheet is threaded onto a core shaft that lies on the reel drum.

Once a paper web is formed and dried, in one embodiment, the coating composition may be applied to the web. In general, the coating composition may be applied to only one side of the web, or the coating composition may be applied to each side of the web. Preferably, the process starts with a roll of web material that is to be treated. The roll to be treated is loaded in an unwind roll-station. The web is threaded from the unwind roll through a nip between the transfer/applicator roll and the applicator roll. The machine is started and runs at a slow speed to ensure that the web will not break. Liquid chemistry is then added to the nip created between the mayer rod and the applicator roll. It should also be noted that the mayer rod rotates in the opposite direction of the applicator roll to control the volume of applied liquid. The liquid that is to be applied to the web is disposed on the applicator roll.

The liquid chemistry is applied to the web at the nip between the applicator roll and the trailing edge of the coater. The nip opening size is determined by the operator. Sometimes closed nips are used, while other times the nip is slightly open which allows less deformity of the web due to nip pressure. As described herein only one side of the web is coated with chemistry. However, there is also an option to coat both sides of the tissue.

Without being bound by any theory, it is believed that for a given coating formulation, coat weight is dependent on four factors: the absorbency of the sheet, applicator roll speed, mayer rod size, and air bladder pressure. Preferably the applicator roll is generally run in the direction of web travel at a rate that is preferably from about 10 to about 70% slower than the web speed and still more preferably from about 30 to about 60% slower than the web speed. For application of coating weights in the range from about 2 to about 25 g/m², a mayer rod having a diameter from about 3 to about 25 mm is preferable. The mayer rod may be smooth or may have a plurality of grooves disposed along its surface. Where the mayer rod possesses a plurality of grooves, the grooves are preferably in the range from about 0.05 to about 3 mm and more preferably from about 0.1 to about 1 mm. In preferred coating applications, the air bladder ranges from about 5 to about 25 PSI and still more preferably from about 5 to about 10 PSI. In general, as soon as enough pressure is developed to deform the applicator roll covering, increasing the rod pressure decreases coat weight, and decreasing rod pressure increases coat weight.

After the chemistry is applied, the web may optionally be run through a dryer section of the machine. Depending on the desired wetness/dryness of the sheet, the temperature of the dryers is lowered or raised as needed. After the web has been dried, it is rolled up as a treated roll on top of the reel drum.

One significant advantage of the coater of the present invention is its ability to apply high viscosity coatings to tissue. Preferably the coater is capable of applying coatings having a viscosity of at least about 500 cps, measured at 25° C. using a Brookfield viscometer at 100 rpm using a #2 spindle, and more preferably a viscosity of at least about 800 cps and still more preferably a viscosity of at least about 1000 cps. Viscosity is often used as an indication of the molecular weight of the polysiloxane as exact number average or weight average molecular weights may be difficult to determine. The term “viscosity” as used herein refers to the viscosity of coating as delivered by the coater to the applicator roll and may in certain embodiments refer to a coating material that has been diluted or prepared as an emulsion. Exemplary high viscosity coatings include, without limitation, a thermoplastic polymer, such as a dispersion containing a thermoplastic polymer. In other embodiments, the coating may comprise a lotion, a softener, a debonder for cellulosic fibers, or any combination thereof. For example, in one embodiment, the additive composition may comprise a thermoplastic polymer combined with a lotion, a thermoplastic polymer combined with a debonder, or a thermoplastic polymer combined with a softener. In particularly preferred embodiments the coating comprises mixtures of hydrophobic and hydrophilic polysiloxanes such as those disclosed in U.S. Pat. No. 7,186,318, the contents of which are incorporated herein by reference. Still in other embodiments the coating may comprise a film-forming composition and an olefin polymer such as those disclosed in U.S. Published Patent Application No. 2008-0041543, the contents of which are incorporated herein by reference.

In certain embodiments, the coated article may have a coat weight of less than 50 g/m². In an alternative embodiment, the coated article may have a coat weight of less than 40 g/m². In an alternative embodiment, the coated article may have a coat weight of less than 30 g/m². In an alternative embodiment, the coated article may have a coat weight of less than 20 g/m². In an alternative embodiment, the coated article may have a coat weight of less than 10 g/m². In an alternative embodiment, the coated article may have a coat weight in the range of 1 to 10 g/m²; or in another embodiments, the coated article may have a coat weight in the range of 0.1 and 5.0 g/m².

In certain embodiments, the coated article may have a coating thickness in the range of 0.1 to 100 microns. All individual values and sub-ranges from 0.1 to 100 microns are included herein and disclosed herein; for example, the coated article may have a coating thickness from a lower limit of 0.1, 1, 5, 10, 15, 20, 30, 40, 50, 60, 70, 80, or 90 microns to an upper limit of 5, 10, 20, 30, 40, 50, 60, 70, 80, 90, 95 or 100 microns. For example, the coated article may have a coating thickness in the range of 0.1 to 15, 0.1 to 10 microns, or 0.1 to 5 microns.

Embodiments of the present invention may be used in an “in-line process,” that is during the manufacturing of the paper, or in an off-line application. One example is where paper is previously clay-coated on a machine. Then, that product may have the coating composition applied as an alternative to an extrusion coated structure.

In order to apply the coating composition onto the surface of the web and keep the composition on the surface without significant penetration, particle size, viscosity and solids level of a coating dispersion play an important role. If a dispersion has its dispersion particles large enough in size (for example, the particle size is larger than the opening size of the web substrate), no matter how low its viscosity or solids level, the coating composition will stay on the surface of the web. In reality, a dispersion having large particle size tends to be very unstable. For certain polysiloxane coatings, the dispersion usually has an average particle size of less than 5 microns, or furthermore less than 2 microns. The degree of penetration of such a dispersion composition will be determined by its viscosity and solids level. As its viscosity increases, or its solids level increases, the coating composition of the dispersion reduces its degree of penetration. Most of the time, when a dispersion increases its solids level, it usually results in an increased viscosity. However, if a viscosity modifier (or thickener) is used, the solids level may be decoupled from viscosity. A constant solids level of dispersion and an increase of the dispersion viscosity can be obtained by increasing the add-on level of a viscosity modifier. Another way to decouple viscosity of a dispersion from its solid level is to use a foam structure to increase its viscosity while maintaining its solid level constant.

We claim:

1. An apparatus for coating a supported web comprising:
an applicator roll for supporting a web of paper;
a chamber extending substantially across the face of, and parallel to, the applicator roll, the chamber having leading, trailing and side edges, the side edges having sealing means for sealing the chamber when the chamber is positioned against the applicator roll;
a first barrier wall oriented parallel to the trailing edge of the chamber, the barrier wall comprising a mayer rod and a mayer rod holder, the mayer rod abutting the applicator roll forming a seal between the trailing edge and the applicator roll;
a second barrier wall oriented parallel to the leading edge of the chamber, the second barrier wall abutting the applicator roll to form a seal between the leading edge of the chamber and the applicator roll; and
a means for delivering coating liquid to the chamber under pressure.

2. The apparatus of claim 1 further comprising a means for biasing the mayer rod against the applicator roll.

3. The apparatus of claim 2 wherein the means for biasing the mayer rod against the applicator roll comprises a support bar having a first and second face and a pneumatic tube, the first face of the support bar adapted to receive the mayer rod and the second face adapted to receive the pneumatic tube.

4. The apparatus of claim 1 wherein the second barrier wall comprises a doctor blade.

5. The apparatus of claim 4 further comprising an adjusting means for adjusting the position of the doctor blade.

6. The apparatus of claim 1 wherein at least about 30 degrees of the circumference of the applicator roll is opposed by the chamber, measured from the first barrier wall to the second barrier wall.

7. The apparatus of claim 6 wherein the circumference of the applicator roll opposed by the chamber, measured from the first barrier wall to the second barrier wall, is in the range of from about 45 to about 60 degrees.

8. The apparatus of claim 1 wherein the side sealing means comprise a resilient material having a shape that is complementary to the applicator roll.

9. A sealed, pressurized applicator for applying high viscosity coatings to a moving web of tissue paper, the applicator comprising:
an applicator roll for supporting a web of tissue paper;
an elongate body defining a chamber with an elongate opening thereto positionable adjacent to and transversely across the applicator roll, the chamber further having a rear wall opposite from the opening and first and second side walls which extend from the rear wall toward the opening, the first and second sidewalls having a resilient seal configured complementary to the applicator roll for sealing the sidewalls thereto when the same are moved together to seal the chamber;
a metering apparatus adjoining the trailing edge of the chamber, the metering apparatus comprising a mayer rod and a support plate adapted for receiving the same, the metering apparatus abutting the applicator roll forming a seal between the trailing edge of the chamber and the applicator roll;
a leading edge seal abutting the applicator roll to form a seal between the leading edge of the chamber and the applicator roll; and
a means for introducing high viscosity coating into the chamber, the means comprising a distribution header within the chamber, the distribution header having outlet passages and inlet passages for flowing high viscosity coating under pressure into the distribution header for flow through the outlet passages into the chamber.

10. The apparatus of claim 9 further comprising a means for biasing the mayer rod against the applicator roll.

11. The apparatus of claim 10 wherein the means for biasing the mayer rod against the applicator roll comprises a support bar having a first and second face and a pneumatic tube, the first face of the support plate adapted to receive the mayer rod and the second face adapted to receive the pneumatic tube.

12. The apparatus of claim 9 further comprising a doctor blade adjacent to the leading edge of the chamber.

13. The apparatus of claim 12 further comprising a means for biasing the doctor blade against the applicator roll.

14. A method of applying a high viscosity coating composition to a web comprising:
presenting a web having a first surface and a second surface;
applying a high viscosity coating to the surface of an applicator roll traveling through an application zone having spaced leading and trailing edges, a wall intermediate the edges and spaced from the applicator roll and from the leading and trailing edges, and laterally spaced side edges, the application zone being defined between the leading and trailing edges, the high viscosity coating having a viscosity of at least about 500 centipoises;
forming and maintaining a reservoir of high viscosity coating under pressure on the applicator roll throughout the application zone;
metering the high viscosity coating on the applicator roll using a mayer rod at the trailing edge of the application zone;
maintaining the high viscosity coating throughout the application zone under pressure by substantially sealing the side edges of the zone and by forming a liquid seal at a first gap defined between the applicator roll and mayer rod and by establishing a seal at a second gap defined between the leading edge of the application zone and the applicator roll;
continuously flowing high viscosity coating under pressure into the application zone to continuously fill the first gap with coating for forming the liquid seal for sealing the trailing edge of the application zone and preventing entry of air and foreign matter into the application zone and for maintaining a pressurized area of coating throughout the application zone; and
transferring the high viscosity coating from the applicator roll to the first surface of the web without penetrating the first surface.

15. The method of claim 14 wherein the web comprises tissue paper.

16. The method of claim 15 wherein the tissue paper web comprises 50% cellulosic fibers and has a bulk of greater than about 3 cc/g.

17. The method of claim 14 wherein the high viscosity coating has a viscosity of at least about 800 centipoises.

18. The method of claim 14 wherein the step transferring the high viscosity coating from the applicator roll to the first surface of the web results in a web having a coat weight in the range from about 0.1 g/m² to about 50 g/m².

19. The method of claim 14 wherein the step transferring the high viscosity coating from the applicator roll to the first surface of the web results in a web having a coating thickness in the range from about 0.1 to about 100 microns.

20. The method of claim 14 further comprising the step of heating the coating fluid to lower the application viscosity.
